(19) United States
(12) Patent Application Publication
(10) Pub. No.: US 2011/0120566 A1
(43) Pub. Date: May 26, 2011

(54) DISCONTINUOUS SWITCHING FLUID FLOW RATE CONTROL METHOD USING PRESSURE TYPE FLOW RATE CONTROL DEVICE

(75) Inventors: Tadahiro OHMI, Miyagi (JP); Kouji NISHINO, Osaka (JP); Ryousuke DOHI, Osaka (JP); Masaaki NAGASE, Osaka (JP); Katsuyuki SUGITA, Osaka (JP); Kaoru HIRATA, Osaka (JP); Takashi HIROSE, Osaka (JP); Tsutomu SHINOHARA, Osaka (JP); Nobukazu IKEDA, Osaka (JP); Toshihide YOSHIDA, Osaka (JP); Hisashi TANAKA, Osaka (JP)

(73) Assignees: FUJIKIN INCORPORATED, Osaka (JP); NATIONAL UNIVERSITY CORPORATION TOHOKU UNIVERSITY, Miyagi (JP); TOKYO ELECTRON LIMITED, Tokyo (JP)

(21) Appl. No.: 12/950,798

(22) Filed: Nov. 19, 2010

Related U.S. Application Data
(63) Continuation-in-part of application No. PCT/JP2009/001069, filed on Mar. 10, 2009.

(30) Foreign Application Priority Data
May 21, 2008 (JP) 2008-132683

(51) Int. Cl. F17D 1/00

(52) U.S. Cl. 137/12

(57) ABSTRACT

A fluid flow rate control method is provided that uses a flow rate range variable type pressure type flow rate control device provided with at least two or more parallel fluid passages disposed between the downstream side of a control valve of the control device and a fluid supply pipe passage, and orifices having different fluid flow rate characteristics are respectively interposed in parallel fluid passages to pass fluid in a first flow rate region through one orifice for flow rate control, and to pass fluid in a second flow rate region through at least another orifice for flow rate control. Flow rate characteristics of the respective orifices are selected so that a maximum controllable flow rate of fluid in the first flow rate region at low flow rate is smaller than 10% of a maximum controllable flow rate in the second flow rate region at high flow rate.

This is a Continuation-in-Part Application in the United States of International Patent Application No. PCT/JP2009/001069 filed Mar. 10, 2009, which claims priority on Japanese Patent Application No. 2008-132683, filed May 21, 2008. The entire disclosures of the above patent applications are hereby incorporated by reference.

### TECHNICAL FIELD

The present invention relates to improvements in a fluid supply method used for semiconductor manufacturing facilities, chemical industrial facilities, medical industrial facilities, and the like. The present invention relates to a discontinuous switching fluid flow rate control method that uses a pressure type flow rate control device, in which it is possible to downsize the fluid supply device and to reduce its manufacturing cost. Furthermore, the discontinuous switching fluid flow rate control method of the present invention permits an enlarged flow rate control range and maintains a high flow rate control accuracy in the fluid supply system that supplies many types of fluids of differing flow rates to various places, as desired, while performing flow rate control thereof by use of the pressure type flow rate control device.

### BACKGROUND ART

In a semiconductor manufacturing device, or the like, generally, many types of gases supplied from one fluid supply device (hereinafter called a “gas box”) are switched to gas using places (i.e., places that use the gas supplied by the gas box) while controlling their flow rates. For example, as regarding a so-called “etcher,” as shown in FIG. 4, various types of processing gases, whose flow rates are respectively different, are supplied to the etcher C (hereinafter, also called a “process chamber”) through sixteen flow rate control devices A₁ to A₁₆ of one gas box GX. In FIG. 4, reference characters S₁ to S₁₆ denote sixteen gas sources, reference characters A₁ to A₁₆ denote sixteen pressure type flow rate control devices, reference characters Ar to O₂ denote the various gas types, and 1600 SCCM to 50 SCCM are maximum flow rates of N₂ gases (wherein “SCCM” stands for standard cubic centimeters per minute) that are converted into standard states, of the pressure type flow rate control devices.

Thus, in the conventional fluid supply device GX connected to the etcher C shown in FIG. 4, the sixteen pressure type flow rate control devices A₁ to A₁₆ are provided to switch gases at desired flow rates in predetermined timings to supply the various gases through gas supply lines L₁ to L₁₆, respectively, wherein each of the gas supply lines L₁ to L₁₆ may have different flow rates and gas types.

Furthermore, there may be a plurality of supply lines for the same type of gas among the respective gas supply lines L₁ to L₁₆, (see, e.g., oxygen in FIG. 4, which has three different supply lines L₁₀, L₁₁, and L₁₆), and among those, there are gas supply lines through which gases are not simultaneously supplied. For example, O₂ (100 SCCM) from the gas source S₁₀ and O₂ (2000 SCCM) from the gas source S₁₁ are not simultaneously supplied to the process chamber C in any case as is known. In addition, in some cases, O₂ (50 SCCM) from the gas source S₁₆ is simultaneously supplied with O₂ from the gas source S₁₀, or simultaneously with O₂ from the gas source S₁₁ instead.

As described above, because the O₂ supply line L₁₀ of the gas source S₁₀ and the O₂ supply line L₁₁ of the gas source S₁₁ are lines through which simultaneous oxygen supply is not performed, then provided that the flow rate control accuracies of the pressure type flow rate control device A₁₀ and of the pressure type flow rate control device A₁₁ are maintained with the required accuracies, both of these gas supply lines L₁₀ and L₁₁ may be replaced with one single O₂ supply line that uses only one pressure type flow rate control device.

On the other hand, the pressure type flow rate control device has circuit configurations, as shown in FIG. 5A and 5B, wherein the former pressure type flow rate control device (FIG. 5A) is mainly used for the case where a ratio P₂/P₁ of an orifice upstream side gas pressure P₁ and an orifice downstream side gas pressure P₂ is equal to or less than a critical value of fluid (i.e., when a gas flow is always in a critical state), and a flow rate Qc of the gas passed through the orifice 8 is given by Qc=KP₁ (where K is a proportional constant). Furthermore, the latter pressure type flow rate control device (FIG. 5B) is mainly used for flow rate control of gases in both flow states including a critical state and a noncritical state, and the flow rate of gas passed through the orifice 8 is given under these circumstances. as Qc=KP₂^{m}(P₁−P₂)ⁿ, (where K is a proportional constant, and m and n are constants).

In FIGS. 5A and 5B, which schematically illustrate different flow control systems (FCS), reference numeral 2 denotes a control valve, reference numeral 3 denotes an orifice upstream side pipe passage, reference numeral 4 denotes a valve driving unit, reference numeral 5 denotes an orifice downstream side pipe passage, reference numerals 6 and 27 denote pressure sensors, reference numeral 7 denotes a temperature detector, reference numeral 8 denotes an orifice, reference numeral 9 denotes a valve, reference numerals 13 and 31 denote flow rate arithmetic circuits, reference numeral 14 denotes a flow rate setting circuit, reference numeral 16 denotes an arithmetic control circuit, reference numeral 12 denotes a flow rate output circuit, reference numerals 10, 11, 22, and 28 denote amplifiers, reference numeral 15 denotes a flow rate conversion circuit, reference numerals 17, 18, and 29 denote A/D converters, reference numeral 19 denotes a temperature correction circuit, reference numerals 20 and 30 denote arithmetic circuits, reference numeral 21 denotes a comparison circuit, reference character Qc denotes a computed flow rate signal, reference character Qe denotes a flow rate setting signal, reference character Qo denotes a flow rate output signal, reference character Qy denotes a flow rate control signal, reference character P₁ denotes orifice upstream side gas pressure, reference character P₂ denotes orifice downstream side gas pressure, and reference character k denotes a flow rate conversion rate. Po denotes a supply pressure.

In flow rate setting, a voltage value is provided as a flow rate setting signal Qe, and usually, a pressure control range of 0 to 3 (kgf/cm² abs) of upstream side pressure P₁ is indicated as a voltage range of 0 to 5V. Thus, Qe=5V (full-scale value) is a full-scale flow rate corresponding to the flow rate Qc=KP₁ at a pressure P₁ of 3 (kgf/cm² abs). For example, assuming that a conversion rate k of the flow rate conversion circuit 15 is set to 1, a computed flow rate signal Qc is 5V by inputting the flow rate setting signal Qe=5V, and the control valve 2 is operated to be opened and closed until the upstream side pressure P₁ reaches 3 (kgf/cm² abs), and the gas at a flow rate Qc=KP₁, corresponding to P₁=3(kgf/cm² abs), is passed through the orifice 8.

Furthermore, in the case where the pressure range to be controlled is switched to a range of 0 to 2 (kgf/cm² abs), and the pressure range is indicated by a flow rate setting signal Qe of 0 to 5 (V), (i.e., in the case where the full-scale value of 5V provides a pressure of 2(kgf/cm² abs)), the flow rate conversion rate k is set to ⅔. As a result, when the flow rate setting signal Qe=5 (V) is input, a switched computed flow rate signal Qf is Qf=5×⅔ (V) on the basis of Qf=kQc, and the control valve 2 is operated to be opened and closed until the upstream side pressure P₁ reaches 3×⅔=2 (kgf/cm² abs). That is, a full-scale flow rate is converted so as to indicate a flow rate Qc=KP₁ corresponding to P₁=2 (kgf/cm² abs).

In a critical state, the flow rate Qc of a gas passed through the orifice 8 is given by the relationship Qc=KP₁. On the other hand, when a gas type to be subjected to flow rate control is changed, its proportional constant k varies even with the same orifice 8. This fact is the same as in the pressure type flow rate control device of FIG. 5B. Even when the same orifice 8 is used, a proportional constant K varies when the gas type is changed. In other words, the proportional constant K depends on the type of gas flowing through the orifice 8.

The pressure type flow rate control device has excellent characteristics in that it not only has simplicity of structure, but also its responsiveness, control accuracy, control stability, manufacturing cost, maintenance, and the like, are excellent. However, because the flow rate Qc is computed as Qc=KP₁ under the critical condition in the pressure type flow rate control device shown in FIG. 5A, its flow rate control range becomes gradually narrower as the orifice secondary side pressure P₂ rises. This result is observed because, since the orifice primary side pressure P₁ is controlled to be a constant pressure value according to the flow rate setting value, when the orifice secondary side pressure P₂ rises in the state in which P₂/P₁ satisfies the critical expansion condition, then the adjustable range of the orifice primary side pressure P₁, i.e., the control range of the flow rate Qc by P₁, becomes inevitably narrower. Therefore, when the controlling flow rate of the fluid is lowered so that it is out of the critical condition, its flow rate control accuracy considerably deteriorates. In the same way, in the pressure type flow rate control device of FIG. 5B, as well, the computed flow rate value is corrected so that it is approximated to an actual measurement flow rate value by appropriately selecting constants m and n. Furthermore, when the controlling flow rate of the fluid is lowered, its flow rate control accuracy is inevitably deteriorated as well.

In more detail, in the pressure type flow rate control device of FIG. 5A, which performs flow rate control of fluid under the critical condition, the current flow rate control accuracy, i.e., the limit to flow rate control error, is within ±1.0% Set Point (S.P.), (under the condition that the flow rate setting signal is within a range of from 10 to 100%) and within ±0.1% Full Scale (F.S.), (under the condition that the flow rate setting signal is within a range from 1 to 10%). In addition, ±1.0% S.P. and ±0.1% F.S., respectively, show a percentage error with respect to the set point flow rate and the percentage error with respect to the full-scale flow rate.

On the other hand, a pressure type flow rate control device, for a semiconductor manufacturing device, is required to have not only a high flow rate control accuracy, but also a wide range of flow rate control. Therefore, when the required flow rate control range is wide, its flow rate control region is divided into a plurality of regions, and pressure type flow rate control devices with different maximum flow rates, which take charge of the respective divided regions, are respectively employed.

However, in the case where a plurality of flow rate control devices are employed, the device is inevitably increased in size and cost, which brings about various disadvantages. Therefore, the inventors have previously developed and disclosed a flow rate switching type pressure type flow rate control device that is capable of performing flow rate control for a wider flow rate region at a relatively high accuracy by using one pressure type flow rate control device as shown in FIG. 6.

The flow rate switching type pressure type flow rate control device of FIG. 6 is configured so that a switching valve 34, a switching electromagnetic valve 32, a low flow rate orifice 8a, and a high flow rate orifice 8c are combined to perform flow rate control, respectively, for a flow rate up to 200 SCCM by using the low flow rate orifice 8a, and for a flow rate from 200 up to 2000 SCCM by using the high flow rate orifice 8c in the case wherein flow rate control is performed up to a maximum flow rate of 2000 SCCM. In more detail, in the case of control for a low flow rate up to 200 SCCM, the flow rate control is performed under the conditions wherein the switching valve 34 is maintained in a closed state, and the flow rate Qs of the fluid passed through the low flow rate orifice 8a is Qs=KsP₁ (where Ks is a constant unique to the orifice 8a). In other words, the fluid passing through the low flow rate orifice 8a is in the critical state. The flow rate characteristics curve for fluid flowing through the low flow rate orifice 8a under these conditions is shown by characteristics curve “S” in FIG. 7. Furthermore, in the case of control for fluid at a flow rate of 2000 SCCM or less down to a lower limit of 200 SCCM, the switching valve 34 is opened via the switching electromagnetic valve 32. Once the switching valve is opened, the fluid flows into the pipe passage 5 through pipe passage 5a, the switching valve 34, and the high flow rate orifice 8c, and in parallel through the low flow rate orifice 8a and the pipe passage 5g. In this case of parallel flow, the flow rate of the fluid flowing into the pipe passage 5 is a sum of the controlling flow rate Qc=KcP₁ of fluid flowing through the high flow rate orifice 8c (where Kc is a constant unique to the high flow rate orifice 8c) and the controlling flow rate Qs=KsP₁ of fluid flowing through the low flow rate orifice 8a (where Ks is a constant unique to the low flow rate orifice 8a), and the flow rate characteristics curve for this parallel flow is one shown by the curve “L” in FIG. 7.

The illustration of the relationship between the controlling flow rate regions of both flow rate characteristics S and L is as shown in FIG. 8(A). As described above, in the case where the setting signal is 10 to 100% (that is, in the case of control with the low flow rate characteristics S, when the flow rate is 20 to 200 SCCM), in order to set the flow rate control error within ±1.0% S.P., the minimum flow rate control value becomes 20 SCCM.

On the other hand, in the case where the flow rates of the gas source S₁₀ (100 SCCM) and the gas source S₁₁ (2000 SCCM) in FIG. 4 are switched to be controlled by use of one switching type pressure type flow rate control device, and in the case of flow rate control for a continuous range as shown in FIG. 8(A), the controlling flow rate of 20 SCCM or more (i.e., corresponding to a setting signal that is 10% or more) is required in order to maintain the flow rate control error within ±1.0% S.P. Therefore, in the case where the O₂ supply flow rate from the gas source S₁₀ is provided at the maximum flow rate of 100 SCCM, during flow rate control for the continuous range as shown in FIG. 8 (A), there is an uncontrolled flow rate range that reaches up to 20 SCCM as a maximum, which extremely degrades the flow rate control accuracy for the low flow rate region. In other words, under these circumstances, the use of one switching type pressure type flow rate control device does not permit accurate flow rate control in the flow rate range of up to 20 SCCM.

Furthermore, in order to improve the flow rate control accuracy, as shown in FIG. 8 (B), the number of switching steps may be set to three steps (for example, three flow rate regions of 20 SCCM, 200 SCCM, and 2000 SCCM, maximum), and the flow rate uncontrolled range may be set to 2 SCCM or less (i.e., 20 SCCM×10%). Thus, as shown in FIG. 8(B), the controlled low flow rate region is from 2 SCCM to 20 SCCM, a controlled intermediate flow rate region is from 20 SCCM to 200 SCCM, and a controlled high flow rate region is from 200 SCCM to 2000 SCCM. However, in this case, there is a drawback in that the orifices 8 to be used must include three types, and the switching type pressure type flow rate control device has a complex structure, which increases its manufacturing cost, and maintenance cost, and operation cost.

Patent Document 1: Japanese Published Unexamined Patent Application No. 2003-195948

Patent Document 2: Japanese Published Unexamined Patent Application No. 2004-199109

Patent Document 3: Japanese Published Unexamined Patent Application No. 2007-4644

### Problems to be Solved by the Invention

The present invention solves the above-described problem that occurs in the flow rate control method using a conventional flow rate switching type pressure type flow rate control device of the continuous flow rate range type, namely, the problem that it is necessary to increase the number of switching steps of the switching type pressure type flow rate control device in order to improve flow rate control accuracy for a low flow rate region (hereinafter called a “first flow rate region”), which brings about an increase in size of the flow rate control device and an increase in manufacturing cost. An object of the present invention, then, is to provide a discontinuous switching fluid flow rate control method that uses a pressure type flow rate control device in which flow rate control, using a switching type pressure type flow rate control device, is a discontinuous type flow rate control, so it is possible to switch the first flow rate region and a high flow rate region (hereinafter called a “second flow rate region”) without degrading the flow rate control accuracy for the first flow rate region, while downsizing the device and considerably reducing its manufacturing cost.

### Means for Solving the Problems

Conventionally, in the case where flow rate control is performed so that a desired flow rate range, for example, a flow rate range of 0 to 2000 SCCM is divided into a plurality of flow rate control regions in order to improve the flow rate control accuracy for the first flow rate region, as shown in FIGS. 8A and 8B, flow rate control for the flow rate range of 2 to 2000 SCCM is continuously performed by a pressure type flow rate control device using orifices for two types of flow rate regions, namely 200 to 2000 SCCM (high flow rate region) and 20 to 200 SCCM (low flow rate region), respectively, or a pressure type flow rate control device that uses orifices for three types of flow rate regions, namely, 200 to 2000 SCCM, 20 to 200 SCCM, and 2 to 20 SCCM. However, in such continuous flow rate control methods, it is necessary to inevitably increase the number of switching steps to make the flow rate adjusting orifice for the minimum flow rate region to be rated at a low flow rate in order to improve the flow rate control accuracy for the first flow rate region. This is because, in the pressure type flow rate control device, the controlling flow rate at which a flow rate control error can be maintained within ±1.0% S.P. is limited to a flow rate range of 10 to 100% of the rated flow rate.

### SUMMARY OF THE INVENTION

In view of the above, the inventors have conceived the idea of utilizing a discontinuous type flow rate control method in which flow rate control for an intermediate flow rate region is eliminated as a way to improve flow rate control accuracy for the first flow rate region without increasing the number of switching steps of the flow rate control range, i.e., by using fewer types of control orifices. The inventors have conducted a large number of flow rate control experiments on the basis of the above idea.

In more detail, as shown in FIG. 1, for example, in the case where flow rate control for the flow rate range of 0 to 2000 SCCM is performed, the flow rate controlling orifice for the range of 200 to 2000 SCCM and the flow rate controlling orifice for a range of 10 to 100 SCCM are combined in one pressure type flow rate control device, and the single pressure type flow rate control device performs flow rate control for both the region of 10 to 100 SCCM and the region of 200 to 2000 SCCM, respectively, operating as the pressure type flow rate control device having the former low flow rate controlling orifice and as the pressure type flow rate control device having the latter high flow rate controlling orifice. However, the pressure type flow rate control device of the present invention handles the flow rate region of 100 to 200 SCCM as a so-called “flow rate uncontrolled region,” which is not subjected to flow rate control.

By adopting the method of a discontinuous type flow rate control, it is possible to perform, in accordance with the present invention, flow rate control at a minimum flow rate of 1 SCCM with a flow rate control error within ±1.0% S.P., which makes it possible to perform highly accurate flow rate control up to a lower flow rate region by using a flow rate switching type pressure type flow rate control device with a simpler structure. As a result, even when the gas supply line L₁₀ and the gas supply line L₁₁ in FIG. 4 are provided as one supply line, for example, it is possible to perform the flow rate control of O₂ in different flow rate regions of 100 SCCM and 2000 SCCM by using one switching type pressure type flow rate control device, and additionally flow rate control is provided with a flow rate control error within ±1.0% S.P. (in a flow rate range of 10 to 100%).

The present invention has been developed through the above-described processes. The invention according to a first embodiment is characterized in that a pressure type flow rate control device computes a flow rate of a fluid passed through an orifice as Qc=KP₁ (where K is a proportional constant), or as Qc=KP₂^{m}(P₁−P₂)ⁿ (where K is a proportional constant, and m and n are constants), from the orifice upstream side pressure P₁ and the orifice downstream side pressure P₂, and wherein at least two or more parallel fluid passages are provided as fluid passages between the downstream side of the control valve of the pressure type flow rate control device and the fluid supply pipe passage, and orifices having different fluid flow rate characteristics are respectively interposed in the respective parallel fluid passages in order to pass fluid in a first flow rate region through one orifice for flow rate control of the fluid in the first flow rate region, and in order to pass fluid in a second flow rate region through at least the other orifice for flow rate control of the fluid in the second flow rate region. In the method, in accordance with the present invention, the minimum flow rate in the second flow rate region is higher than the maximum flow rate in the first flow rate region, and the flow rate region between the minimum flow rate in the second flow rate region and the maximum flow rate in the first flow rate region is freely switchable as an uncontrolled region.

The invention, according to a second embodiment, is that in the invention according to the first embodiment, the flow rate control of the second flow rate region and the flow rate control of the first flow rate region are discontinuous, and a flow rate region between the second flow rate region and the first flow rate region is not subjected to flow rate control.

The invention according to a third embodiment is that, in the invention according to the first embodiment, the number of parallel fluid passages is two, and the two orifices are provided as a first flow rate region orifice and as a second flow rate region orifice.

The invention according to a fourth embodiment is that, in the invention according to the third embodiment, the fluid passed through the orifice is set to be a fluid under a critical condition, and the control range of the fluid flow rate is switched between the first flow rate region and the second flow rate region by operation of a switching valve provided in the fluid passage of the second flow rate region orifice.

The invention according to a fifth embodiment is that, in the invention according to the first embodiment, the first flow rate region has a numerical value selected from within the range of from 10 to 1000 SCCM as an upper limit, and a value that is 1 SCCM or more and smaller than the above upper limit as the lower limit, and the second flow rate region has a numerical value selected from within the range from 100 to 5000 SCCM as the lower limit, and a value that is 10000 SCCM or less and is larger than the above lower limit as an upper limit.

In accordance with the present invention, the flow rate control error is set within ±1.0% S.P. within a range from 100% to 10% of its maximum flow rate.

In accordance with the present invention, for example, the maximum flow rate of the fluid in the first flow rate region is set to one of 50 SCCM, 65 SCCM, 100 SCCM, 200 SCCM, and 1000 SCCM.

In accordance with the present invention, for example, the maximum flow rate of the fluid in the second flow rate region is set to one of 1000 SCCM, 1500 SCCM, 2000 SCCM, 3000 SCCM, and 10000 SCCM.

### Effects of the Invention

In the invention of this application, by selecting to use a flow rate controlling orifice corresponding to a flow rate control range in the first flow rate region, which is required, it becomes possible to perform highly accurate flow rate control for the first flow rate region and the second flow rate region by use of the flow rate switching type pressure type flow rate control device constructed with a simpler structure. Although the flow rate control accuracy is not secured in the intermediate flow rate region, it is possible to perform rough flow rate control, which provides a practical and excellent utility.

### BRIEF DESCRIPTION OF THE DRAWINGS

FIG. 1 is an explanatory diagram of a discontinuous switching flow rate control method according to the present invention.

FIG. 2 is an explanatory schematic diagram of the configuration of a flow rate switching type pressure type flow rate control device used for the present invention.

FIG. 3 is an explanatory diagram showing another example of the discontinuous switching flow rate control method according to the present invention.

FIG. 4 is an explanatory schematic diagram showing an example for explanation of gas supply for an etcher in a conventional semiconductor manufacturing device (prior art).

FIG. 5A is a system diagram showing an example of a pressure type flow rate control device. FIG. 5B is a system diagram showing another example of the pressure type flow rate control device.

FIG. 6 is a system diagram of a conventional flow rate switching type pressure type flow rate control device (prior art).

FIG. 7 is a flow rate control characteristics diagram of the flow rate switching type pressure type flow rate control device of FIG. 6.

FIG. 8 (A) is an explanatory diagram of a continuous type flow rate control region by the flow rate switching type pressure type flow rate control device. FIG. 8 (B) is an explanatory diagram of a continuous type flow rate control region in the case wherein three types of flow rate switching regions are provided in order to improve the flow rate control accuracy in a low flow rate region.

FIG. 9 is an explanatory diagram with respect to the terms “Set Point” and “Full Scale” as used in the present disclosure.

### DESCRIPTION OF SYMBOLS

A: flow rate switching type pressure type flow rate control device, Gc: driving gas, Qe: setting input signal, Qo: flow rate output signal, S_{L}, S_{S}: flow rate region switching signals, C₁: switching signal, P₀: supply side pressure, P₁: orifice upstream side pressure, GX: fluid supply device (gas box), A₁ to Aₙ: pressure type flow rate control devices, C: etcher (process chamber), S₁ to Sₙ (wherein n=16): gas sources, Ar to O₂: processing gases, L₁ to Lₙ (wherein n=16): gas supply lines, F100: control region by pressure type flow rate control device whose maximum flow rate is 100 SCCM, F2L: control region by pressure type flow rate control device whose maximum flow rate is 2000 SCCM, B: flow rate uncontrolled region, 1: control unit, 2: control valve, 3: orifice upstream side pipe passage, 4: driving unit, 5: orifice downstream side pipe passage, 6: pressure sensor, 7: temperature detector, 8: orifice, 8a′: first flow rate region orifice, 8c: second flow rate region orifice, 32: switching electromagnetic valve, 34: switching valve, 34a: valve driving unit, 34b: proximity sensor (limit switch)

### DETAILED DESCRIPTION OF THE INVENTION WITH BEST MODES FOR CARRYING OUT THE INVENTION

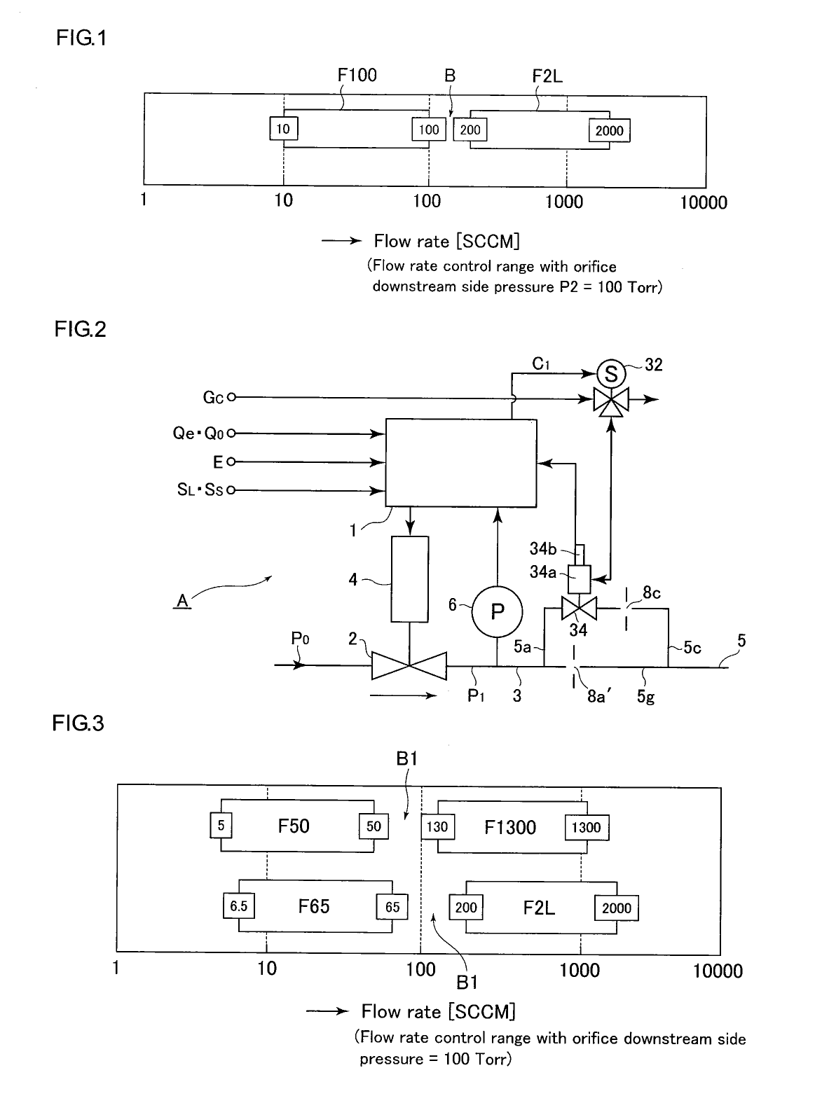

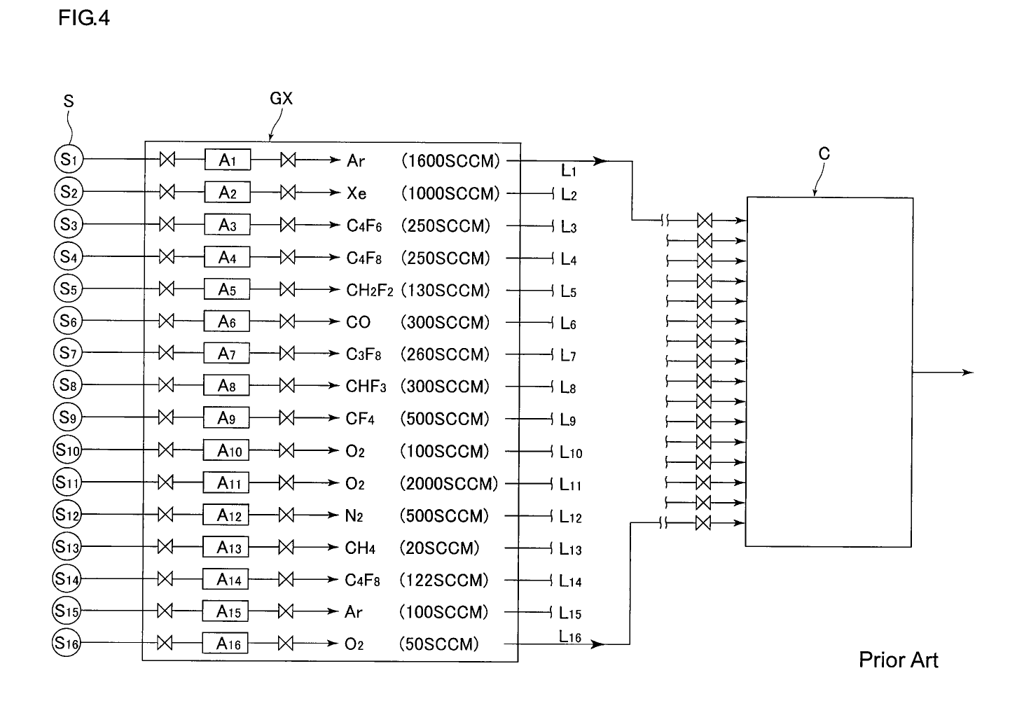

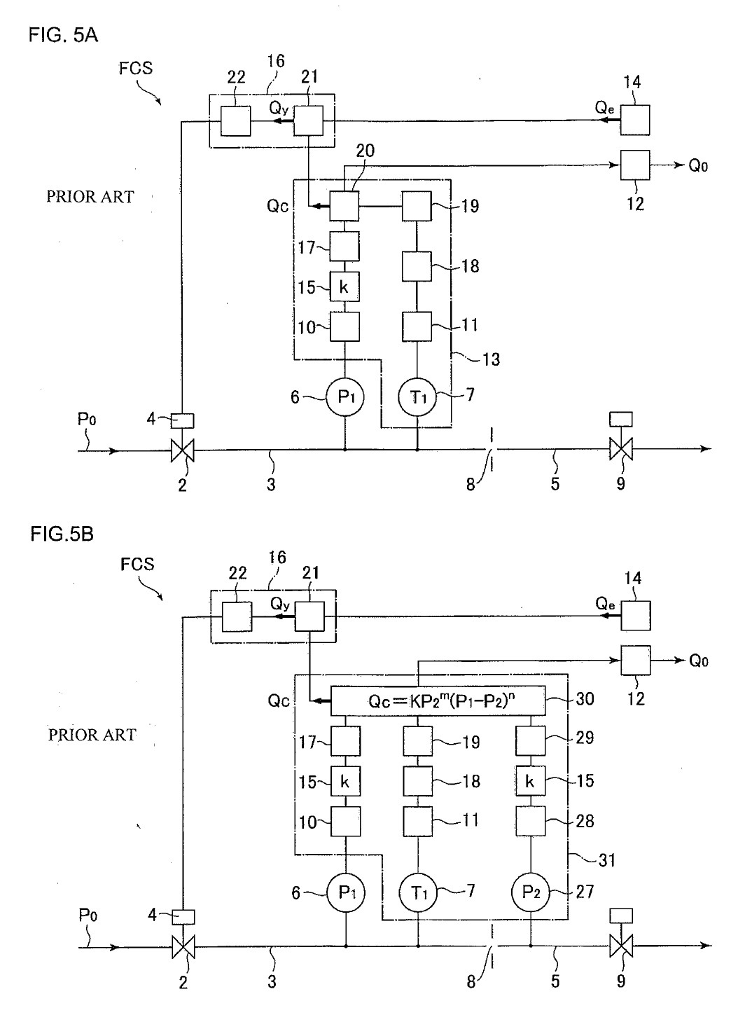

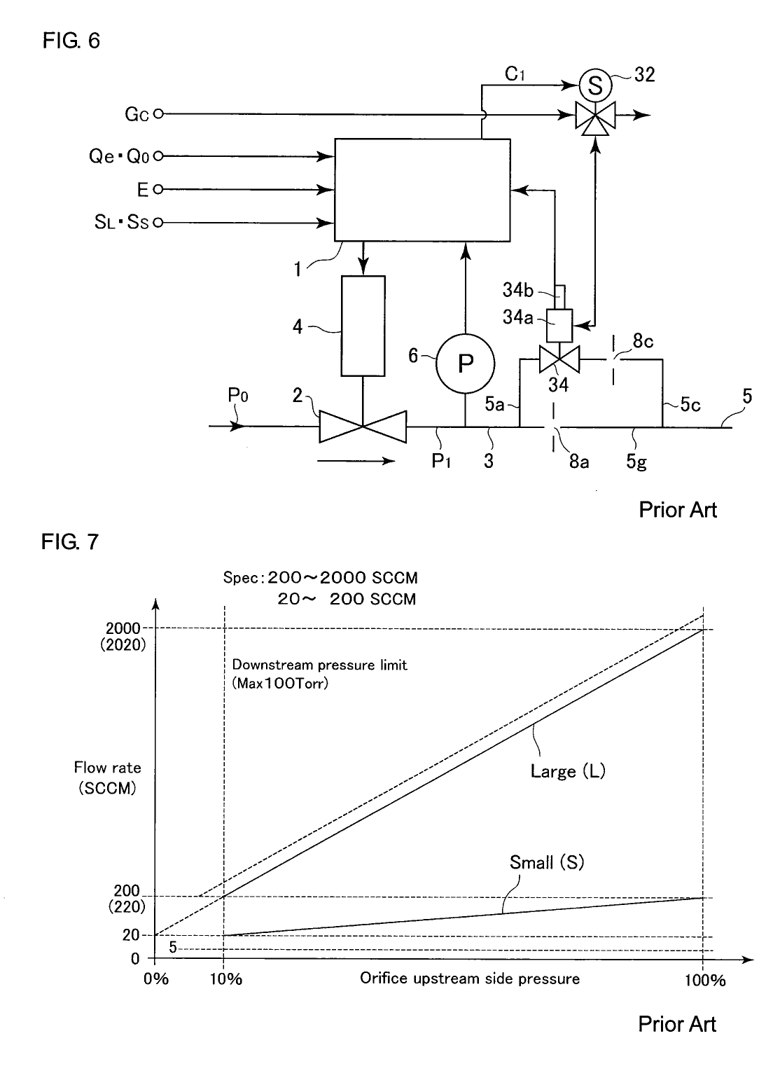

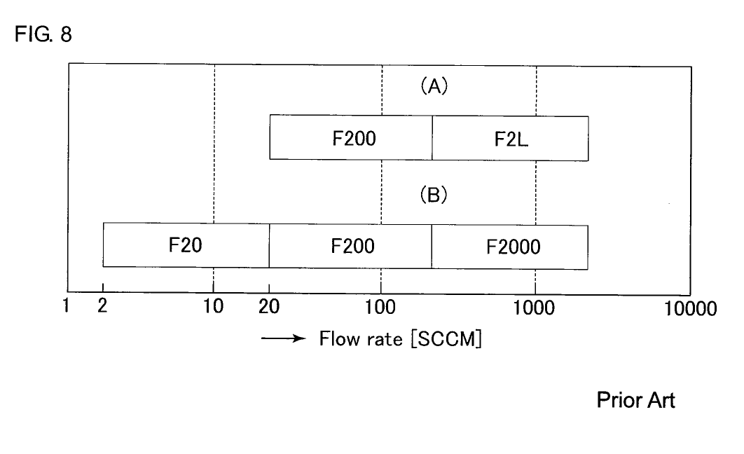

Hereinafter, an embodiment of the present invention will be described with reference to the accompanying drawings. FIG. 2 is an explanatory schematic diagram of the configuration of the flow rate switching type pressure type flow rate control device A used for carrying out the present invention. The flow rate switching type pressure type flow rate control device A itself is the same as the conventional flow rate control device shown in FIG. 6, and only the orifice diameter of the first flow rate region orifice 8a′ to be used is different. In FIG. 2, reference numeral 1 denotes a control unit, reference numeral 2 denotes a control valve, reference numeral 3 denotes an orifice upstream side (primary side) pipe passage, reference numeral 4 denotes a driving unit, reference numeral 5 denotes a fluid supply pipe passage, reference numeral 6 denotes a pressure sensor, reference numeral 8a′ denotes a first flow rate region orifice, reference numeral 8c denotes a second flow rate region orifice, reference numeral 32 denotes a switching electromagnetic valve, and reference numeral 34 denotes a switching valve. The control unit 1, the control valve 2, the valve driving unit 4, the pressure sensor 6, and the like, in the pressure type flow rate control device are publicly known, and flow rate input and output signal terminals Qe and Qo (i.e., a setting flow rate input signal Qe and a controlling flow rate output signal Qo, 0 to 5V DC), power supply terminal E (±15V DC), and input terminals S_{L} and S_{S}, for controlling flow rate switching command signals, are provided. In some cases, input and output signal terminals are used for serial digital signal communication.

The switching electromagnetic valve 32 is a publicly-known air operated electromagnetic valve. When a switching signal C₁ is input from the control unit 1, the driving gas Gc (at 0.4 to 0.7 MPa) is supplied to operate the switching electromagnetic valve 32. Consequently, the driving gas Gc is supplied to the valve driving unit 34a of the switching valve 34 in order to operate the switching valve 34 so as to be opened and closed. Furthermore, operation of the switching valve 34 is detected by a proximity sensor (limit switch) 34b that is provided for each valve driving unit 34a, and the detection signal is input to the control unit 1. In addition, a pneumatically-operated normally-closed type valve is used as the switching valve 34.

Pipe passages 5a and 5c form a bypass passage with respect to the orifice 8a′. In the case where the controlling flow rate is in the first flow rate region, fluid is subjected to flow rate control by the first flow rate region orifice 8a′ and is passed through the pipe passage 5g. Furthermore, in the case wherein the controlling flow rate is in the second flow rate region, fluid flows into the second flow rate region orifice 8c through the pipe passage 5a, and the fluid that is subjected to flow rate control mainly by flowing through the second flow rate region orifice 8c flows into the fluid supply pipe passage 5 via pipe passage 5c.

Now, it is assumed that the total flow rate range up to 2000 SCCM is divided into a first flow rate region of up to 100 SCCM and into a second flow rate region from 200 SCCM up to 2000 SCCM in order to perform flow rate control. In this case, at the time of flow rate control up to 100 SCCM, the switching valve 34 is maintained in a closed state and the flow rate Qs of fluid passed through the low flow rate orifice 8a′ is set to Qs=KsP₁ (where Ks is a constant unique to the orifice 8a′), in order to perform the flow rate control. It is as a matter of course that an orifice, having a maximum flow rate of 100 SCCM, is used as the orifice 8a′. With flow rate control using solely the first flow rate region orifice 8a′, the flow rate control is performed with an accuracy having an error within ±1.0% S.P. over the range of flow rates of 100 SCCM to 10 SCCM at 100 Torr, or less, in the orifice downstream side pipe passage 5.

On the other hand, in the case wherein flow rate control is performed in the second flow rate region of 200 to 2000 SCCM, the switching valve 34 is opened via the switching electromagnetic valve 32. In this way, fluid flows into the pipe passage 5 through the pipe passage 5a, and the switching valve 34, and the second flow rate region orifice 8c and the first flow rate region orifice 8a′, and the pipe passage 5g. In other words, the flow rate of fluid flowing into the pipe passage 5 is the sum of the controlling flow rate Qc=KcP₁ provided by the second flow rate region orifice 8c (where Kc is a constant unique to the second flow rate region orifice 8c) and the controlling flow rate Qs=KsP₁ provided by the first flow rate region orifice 8a′ (where Ks is a constant unique to the first flow rate region orifice 8a′). In other words, the total flow rate Q_{T}=Qc+Qs, wherein highly accurate flow rate control with an error within ±1.0% S.P. is performed over the flow rate region of flow rates of 200 to 2000 SCCM (flow rate of 10% to 100% of maximum flow of 2000 SCCM) at the orifice downstream side pressures for the orifices 8c and 8a′ at 100 Torr or less. In addition, as shown in FIG. 2, the flow rate control range is divided into two flow rate regions by the use of the two orifices 8a′ and 8c. Furthermore, it is as a matter of course that two or more orifices and parallel pipe passages may be provided to further divide the flow rate control range into three or more flow rate regions within the scope of the invention.

FIG. 1 is an explanatory diagram of a discontinuous switching flow rate control method, according to the present invention. FIG. 1 shows that, provided the pressure type flow rate control device F100 whose maximum flow rate is 100 SCCM when using the first flow rate region orifice 8a′, and the pressure type flow rate control device F2L whose maximum flow rate is 2000 SCCM using both of the second flow rate region orifice 8c and the first flow rate region orifice 8a′, are switched in order to be used together, it is possible to perform flow rate control with an error within ±1.0% S.P. up to the flow rate value of 10 SCCM even at the orifice downstream side pressure of 100 Torr or less. In addition, the flow rate region B (i.e., 100 SCCM to 200 SCCM) in FIG. 1 is a range in which the flow rate control accuracy with an error within ±1.0% S.P. cannot be secured, which means that it is a discontinuous region of flow rate control (i.e., the uncontrolled flow rate region, or “region of uncontrolled flow rates”) in accordance with the present invention.

In the above-described embodiment, the discontinuous switching flow rate control method has been described, which uses the pressure type flow rate control device F100 whose maximum flow rate is 100 SCCM and the pressure type flow rate control device F2L whose maximum flow rate is 2000 SCCM. In addition, as shown in FIG. 3, another embodiment of a discontinuous switching flow rate control method is described, which pertains to a combination of the pressure type flow rate control devices F50 and F1300, whose maximum flow rates are 50 SCCM and 1300 SCCM, respectively, and a combination of the pressure type flow rate control devices F65 and F2L, whose maximum flow rates are 65 SCCM and 2000 SCCM, respectively, or the like, may be adopted. In addition, the flow rate region B1 (50 SCCM to 130 SCCM) and the flow rate region B2 (65 SCCM to 200 SCCM) are discontinuous regions of flow rate control (i.e., flow rate uncontrolled regions).

In more detail with respect to the embodiment shown in FIG. 3, the maximum controllable flow rate in the first flow rate region, for example, 50, 65, 100, 200, 1000 SCCM, or the like, is selected. Furthermore, generally, the flow rate corresponding to a first numerical value selected from within the range from 10 to 1000 SCCM is selected as the maximum controllable flow rate in the first flow rate region. Furthermore, as the maximum controllable flow rate in the second flow rate region, 1000, 1300, 1500, 2000, 3000, 10000 SCCM, or the like, is selected.

Furthermore, 1 SCCM is selected as the minimum controllable flow rate in the first flow rate region. Furthermore, as the minimum controllable flow rate in the second flow rate region, the flow rate corresponding to a second numerical value selected from within the range from 100 to 5000 SCCM is selected as the minimum controllable flow rate in the second flow rate region. Thus, the minimum controllable flow rate in the first flow rate region is preferably selected to be 1 SCCM and the minimum controllable flow rate in the second flow rate region is preferably selected to be within the range of from 100 SCCM to 5000 SCCM.

That is, the flow rate range in the first flow rate region is the flow rate region from 1 SCCM up to the flow rate corresponding to the first numerical value (which is a selected value), and the flow rate range in the second flow rate region is the flow rate region from the flow rate corresponding to the second numerical value (which is another selected value) up to 10000 SCCM. The intermediate region between the first numerical value of the first flow region and the minimum controllable flow rate in the second flow rate region is the region of uncontrolled flow rates.

### INDUSTRIAL APPLICABILITY

The present invention can be applied to fluid supply of various types of fluids in the semiconductor manufacturing, the chemical industry, the medical industry, the food industry, and the like.

In sum, in accordance with a first illustrative embodiment of the present invention, a discontinuous switching fluid flow rate control method is provided that uses a pressure type flow rate control device, which computes a flow rate of fluid passed through an orifice as Qc=KP₁ (where K is a proportional constant), or Qc=KP₂^{m}(P₁−P₂)ⁿ (where K is a proportional constant, and m and n are constants), from an orifice upstream side pressure P₁ and an orifice downstream side pressure P₂, and in which at least two or more parallel fluid passages are provided as fluid passages between the downstream side of a control valve of the pressure type flow rate control device and a fluid supply pipe passage, and orifices having different fluid flow rate characteristics are respectively interposed in the respective parallel fluid passages to pass fluid in a first flow rate region through one orifice for flow rate control of the fluid in the first flow rate region, and in order to pass fluid in a second flow rate region through at least the other orifice for flow rate control of the fluid in the second flow rate region, wherein the method includes a minimum flow rate in the second flow rate region that is higher than a maximum flow rate in the first flow rate region, and the flow rate region between the minimum flow rate in the second flow rate region and the maximum flow rate in the first flow rate region is an uncontrolled region. In accordance with a second illustrative embodiment of the invention, the method of the first illustrative embodiment is modified so that the flow rate control of the second flow rate region and the flow rate control of the first flow rate region are discontinuous, and the flow rate region between the first flow rate region and the second flow rate region is not subjected to flow rate control.

In accordance with a third illustrative embodiment of the invention, the first illustrative embodiment is modified so that the number of the parallel fluid passages is two, and two orifices are provided as a second flow rate region orifice and a first flow rate region orifice. In accordance with a fourth illustrative embodiment of the present invention, the third illustrative embodiment is further modified so that fluid passed through the orifice is set to be fluid under a critical condition, and the control range of the fluid flow rate is switched between the first flow rate region and the second flow rate region by operation of a switching valve that is provided in a fluid passage of the second flow rate region orifice. In accordance with a fifth illustrative embodiment of the present invention, the first illustrative embodiment is modified so that the first flow rate region has a first upper limit that has a flow rate numerical value selected from within a range of from 10 SCCM to 1000 SCCM, and the first flow rate region has a first lower limit that has a flow rate numerical value that is smaller than the first upper limit by 1 SCCM or more, and the second flow rate region has a second lower limit that has a flow rate numerical value selected from within a range of from 100 SCCM to 5000 SCCM, and the second flow rate region has a second upper limit that has a flow rate numerical value that is 10000 SCCM or less and that is larger than the second lower limit, wherein the first upper limit of the first flow rate region and the second lower limit of the second flow rate region are selected so that the minimum flow rate in the second flow rate region is higher than the maximum flow rate in the first flow rate region.

Thus, in the flow rate control method of the invention a pressure type flow rate control device is used in which flow rate control of fluid is performed by switching between the second flow rate region and the first flow rate region, and the flow rate range, which is controllable within a predetermined error range, is enlarged to further decrease the minimum controllable flow rate. The present invention provides the fluid flow rate control method using a flow rate range variable type pressure type flow rate control device in which at least two or more parallel fluid passages are provided as fluid passages between the downstream side of a control valve of the pressure type flow rate control device and a fluid supply pipe passage, and orifices having different fluid flow rate characteristics are respectively interposed in the respective parallel fluid passages to pass fluid in the first flow rate region through one orifice for flow rate control of the fluid in the first flow rate region, and to pass fluid in the second flow rate region through at least the other orifice for flow rate control of flow rate control device is used in which flow rate control of fluid is performed by switching between the second flow rate region and the first flow rate region, and the flow rate range, which is controllable within a predetermined error range, is enlarged to further decrease the minimum controllable flow rate. The present invention provides the fluid flow rate control method using a flow rate range variable type pressure type flow rate control device in which at least two or more parallel fluid passages are provided as fluid passages between the downstream side of a control valve of the pressure type flow rate control device and a fluid supply pipe passage, and orifices having different fluid flow rate characteristics are respectively interposed in the respective parallel fluid passages to pass fluid in the first flow rate region through one orifice for flow rate control of the fluid in the first flow rate region, and to pass fluid in the second flow rate region through at least the other orifice for flow rate control of fluid in the second flow rate region, and in the method, the flow rate characteristics of the respective orifices are selected so that a maximum controllable flow rate of the fluid in the first flow rate region at a low flow rate is smaller than 10% of a maximum controllable flow rate in the second flow rate region at a high flow rate, so as to reduce the minimum flow rate in the first flow rate region at which it is possible to perform flow rate control within the predetermined flow rate control error.

### Definitions of “Set Point” and “Full Scale”

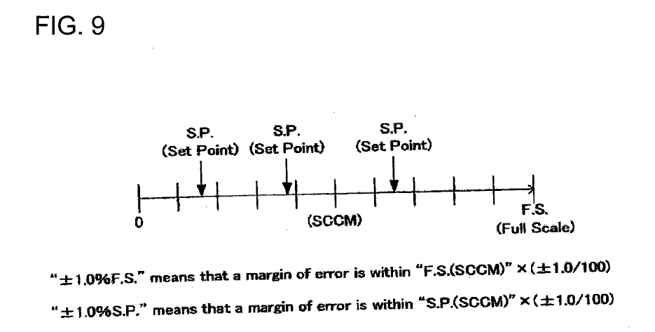

For this disclosure, “S.P.” stands for “Set Point,” which represents a percentage error with respect to a set point flow rate as described above. See also FIG. 9. The set point flow rate is an optionally set setting flow rate. For example, in the case of a flow rate control device controllable with a maximum flow rate of 100 SCCM, ±1.0% S.P. means that an error is within ±1.0% at a flow rate that is optionally set within a range of 10 to 100 SCCM. Therefore, in this case, ±1.0% S.P. means that, for example, an error is within ±0.1 SCCM at the setting flow rate of 10 SCCM, within ±0.5 SCCM at the setting flow rate of 50 SCCM, and within ±1 SCCM at the setting flow rate of 100 SCCM. However, it is difficult from the technological point of view to achieve an error within ±1.0% when the setting flow rate is less than 10% of the controllable maximum flow rate and the controllable maximum flow rate is less than 10 SCCM. Moreover, in the case of a flow rate control device controllable to a maximum flow rate of 2,000 SCCM, ±1.0% S.P. means that, for example, the error is within ±2 SCCM at the setting flow rate of 200 SCCM.

For this disclosure, “F.S.” stands for “Full Scale,” which represents a percentage error with respect to a full-scale flow rate as described above. See also FIG. 9. For example, in the case of a flow rate control device controllable with a maximum flow rate of 100 SCCM, ±0.1% F.S. means that an error is within 0.1 SCCM. In the case of a flow rate control device controllable to a maximum flow rate of 2,000 SCCM, ±0.1% F.S. means that an error is within 2 SCCM even at 2,000 SCCM or at 200 SCCM.

“Setting signals” are “flow rate setting signals Qe” as described above. When a flow rate setting signal is between 10 and 100% of full scale (of 5V, for example), then the flow rate to be controlled will be between 10% and 100% of the maximum controllable flow rate.

1. A discontinuous switching fluid flow rate control method comprising the steps of:
(a) providing a pressure type flow rate control device that comprises:
i. a control valve;
ii. at least two or more parallel fluid passages connected as fluid passages between a downstream side of the control valve and a fluid supply pipe passage; and
iii. a plurality of orifices, wherein each orifice has a different fluid flow rate characteristic from each other orifice of the plurality of orifices, wherein the plurality or orifices are interposed in respective parallel fluid passages so as to pass fluid flowing in a first flow rate region though a first orifice disposed to provide flow rate control of fluid flowing in the first flow rate region and so as to pass fluid flowing in a second flow rate region through at least a second orifice disposed to provide flow rate control of fluid flowing in the second flow rate region; and (
) (b) using the pressure type flow rate control device to provide flow rate control of the fluid, wherein
i. the pressure type flow rate control device computes a flow rate of fluid passed through the first orifice, or the second orifice, or the first orifice and the second orifice, as Qc=KP₁, where K is a proportional constant, from an upstream side pressure P₁; or
ii. the pressure type flow rate control device computes the flow rate of fluid passed through the first orifice, or the second orifice, or the first orifice and the second orifice, as Qc=KP₂^{m}(P₁−P₂)ⁿ, where K is a proportional constant, and m and n are constants, from the orifice upstream side pressure P₁ and an orifice downstream side pressure P₂, wherein
a minimum flow rate in the second flow rate region is higher than a maximum flow rate in the first flow rate region, and
an uncontrolled flow rate region is defined as a third flow rate region including flow rates between the minimum flow rate in the second flow rate region and the maximum flow rate in the first flow rate region.

2. The discontinuous switching fluid flow rate control method according to claim 1, wherein flow rate control of the second flow rate region and flow rate control of the first flow rate region are discontinuous, and the third flow rate region including flow rates between the first flow rate region and the second flow rate region is not subjected to flow rate control.

3. The discontinuous switching fluid flow rate control method according to claim 1, wherein the at least two or more parallel fluid passages consists of two parallel fluid passages, and the plurality of orifices consist of only two orifices that include the second orifice and the first orifice, wherein the second orifice is disposed in one of the two parallel passages and the first orifice is disposed in the other one of the two parallel passages.

4. The discontinuous switching fluid flow rate control method according to claim 3, wherein the fluid passed through the first orifice and the second orifice is fluid under a critical condition, and a control range for the flow rate of the fluid is switched between the first flow rate region and the second flow rate region by operation of a switching valve provided in the one of the two parallel passages in which the second orifice is disposed.

5. The discontinuous switching fluid flow rate control method according to claim 1, wherein the first flow rate region has a first upper limit that has a flow rate numerical value selected from within a range of from 10 SCCM to 1000 SCCM, and the first flow rate region has a first lower limit that has a flow rate numerical value that is smaller than the first upper limit by 1 SCCM or more, and the second flow rate region has a second lower limit that has a flow rate numerical value selected from within a range of from 100 SCCM to 5000 SCCM, and the second flow rate region has a second upper limit that has a flow rate numerical value that is 10000 SCCM or less and that is larger than the second lower limit, wherein the first upper limit of the first flow rate region and the second lower limit of the second flow rate region are selected so that the minimum flow rate in the second flow rate region is higher than the maximum flow rate in the first flow rate region.
